(19) United States
(12) Patent Application Publication
(10) Pub. No.: US 2012/0034523 A1
(43) Pub. Date: Feb. 9, 2012

(54) NEGATIVE ACTIVE MATERIAL FOR RECHARGEABLE LITHIUM BATTERY AND RECHARGEABLE LITHIUM BATTERY INCLUDING SAME

(75) Inventors: Kyeu-Yoon SHEEM, Yongin-si (KR); Sumihito ISHIDA, Yongin-si (KR); Eui-Hwan SONG, Yongin-si (KR); Young-Seak LEE, Daejeon-si (KR)

(73) Assignee: SAMSUNG SDI CO., LTD., Yongin-si (KR)

(21) Appl. No.: 12/974,980

(22) Filed: Dec. 21, 2010

(30) Foreign Application Priority Data
Aug. 6, 2010 (KR) 10-2010-0076095

(51) Int. Cl. H01M 4/62; H01M 4/52; H01M 4/48; B82Y 30/00

(52) U.S. Cl. 429/217; 429/218.1; 429/231.8; 429/220; 429/221; 429/223; 429/231; 429/231.5; 977/734

(57) ABSTRACT

Disclosed are a negative active material for a rechargeable lithium battery and a rechargeable lithium battery including the same. The negative active material may include a metal oxide in an amount of about 20 wt % or more, and has a specific surface area of about 500 m²/g or less. The negative active material may be fiber including carbon black in which a metal oxide is internally impregnated and combined. This fiber includes only carbon black and a metal oxide internally doped. The fiber may have nanofiber having an average diameter ranging from about 50 nm to about 900 nm. In another embodiment, the fiber may have an average diameter ranging from about 150 nm to about 900 nm. When the fiber has an average diameter within these ranges, a metal oxide nanoparticle is internally well-impregnated, accomplishing excellent performance.

### CLAIM PRIORITY

This application claims priority to and the benefit of Korean Patent Application No. 10-2010-0076095 filed in the Korean Intellectual Property Office on Aug. 6, 2010, the entire contents of which are incorporated herein by reference.

### BACKGROUND OF THE INVENTION

1. Field of the Invention

This disclosure relates to a negative active material for a rechargeable lithium battery and a rechargeable lithium battery including the same.

2. Description of the Related Art

Lithium rechargeable batteries have recently drawn attention as a power source for a small portable electronic device. They use an organic electrolyte solution and thereby have twice the discharge voltage of a conventional battery using an alkali aqueous solution. Accordingly, they have high energy density.

As for a positive active material of a rechargeable lithium battery, lithium-transition element composite oxides being capable of intercalating lithium such as LiCoO₂, LiMn₂O₄, LiNi₁₋ₓCoₓO₂ (0<x<1), and so on have been researched.

On the other hand, a negative active material may representatively include amorphous carbon and crystalline carbon. However, since one lithium element per six carbon atoms is theoretically inserted, LiC₆ has a theoretical maximum capacity of about 372 mAh/g. Recently, much research on non-carbon-based materials has been undertaken.

Silicon, tin, and alloys thereof are known to have a reversible electrical chemical reaction with lithium, not through an intercalation reaction in which lithium is inserted between layers, but through a compound-forming reaction. Accordingly, when silicon, tin, or alloys thereof are applied to a negative active material (referred to be a metal-based negative active material), the negative active material may have a theoretical maximum capacity of about 4200 mAh/g and may have excellent capacity compared with a carbon-based negative active material.

However, since the metal-based negative active material has no intercalating reaction unlike a carbon-based negative active material, it may have a slow diffusion reaction, of lithium ions. When it is a bulk-phased large powder, it may suffer severe cracks on the surface during repeated charge and discharge cycles and thus may degrade. As a result, the negative active material may have a larger surface area in contact with an electrolyte, and thus suffer from an active side reaction with the electrolyte, consuming lithium and deteriorating overall conductivity.

Furthermore, as the negative active material powder becomes smaller in size, the newly-formed surface forms inside cracks and thus makes the negative active material nano-sized, causing electrical isolation. In other words, an active material having no activation (dead active material) is prepared. These various processes are continuously repeated, resulting in deterioration in an electrode overall, as cycles proceed.

Accordingly, making a metal-based active material in a nano-size, coating a metal-based active material surface with a non-active metal, and alloying a metal-base active material with a non-active metal in order to suppress cracks on the surface of a negative active material is being researched. However, it is not yet commercially available.

For example, Korean Patent Laid-Open No. 2007-0005149 discloses nano-sized tin powder capped with a monomer as a negative active material for a rechargeable battery. However, since the negative active material is prepared by coating an organic material on nano-sized tin powder with a size of about 10 nm to 300 nm, it may be prepared in a complex and expensive process, which is not particularly commercially viable.

In addition, Korean Patent Laid-Open No. 2008-0098261 discloses a method of applying a nanofiber network phase of tin oxide to an electrode to increase output characteristics using electrical emission. However, since it has such a large surface and thus more contact with an electrolyte, it may not avoid cycle-life degradation due to an SEI (solid electrolyte interface) increase. As it repeatedly contracts and expands, agglomeration of tin metal particles neighboring one another may not be suppressed.

The Journal of Power Sources, 96 (2001) 277-281, discloses a SnO₂-carbon composite for a lithium-ion battery anode prepared by dissolving sugar in a SnO₂ colloid aqueous solution and vacuum-drying and heat-treating the solution to prepare a composite material powder, in which carbon acquired from the sugar is mixed with SnO₂ nanoparticles. This method may secure higher conductivity than a method of simply mixing SnO₂ with a conductive carbon material. However, the composite material may be severely cracked due to difficult processes and expansion bringing about reaction of lithium ions with SnO₂. In addition, an electrolyte is continuously decomposed on the new face, sharply deteriorating a battery.

### SUMMARY OF THE INVENTION

An exemplary embodiment provides a negative active material for a rechargeable lithium battery having improved high-rate and cycle-life characteristics.

Another embodiment provides a rechargeable lithium battery including the negative active material.

Yet another embodiment provides a negative active material for a rechargeable lithium battery, which includes a metal oxide in an amount of about 20 wt % or more and a specific surface area of about 500 m²/g or less.

The specific surface area may be in a range of about 10 m²/g to about 500 m²/g.

The negative active material may include a metal oxide in an amount ranging from about 20 wt % to about 99 wt %.

The negative active material may be a fiber including carbon black, in which a metal oxide is internally impregnated and thus prepared into a composite.

Herein, the metal oxide may be combined with carbon black through a binder.

The binder may include any compound which may be electrospinned. The binder may include polyacrylonitrile, 6,6-nylon, polyurethane, polybenzimidazole, polycarbonate, polyvinyl alcohol, polylacetic acid, polyethylene-co-vinylacetate, polymethylmetaacrylate, polyaniline, polyethylene oxide, collagen, polystyrene, polyvinylcarbazole, polyethylene terephthalate, polyamide, polyamideimide, polyvinylphenol, polyvinylchloride, polyacrylamide, polycaprolactone, polyvinylidene fluoride, polyester amide, polyethylene glycol, polypyrrole, or a combination thereof.

In the negative active material according to one embodiment of the present invention, the metal oxide may be selected from SnO₂, TiO₂, Fe₂O₃, Fe₃O₄, CoO, CO₃O₄, CuO, ZnO, In₂O₃, NiO, MoO₃, WO₃, or a combination thereof.

The fiber may be nanofiber having an average diameter ranging from about 50 nm to about 900 nm.

In the negative active material including a fiber including carbon black internally doped with a metal oxide, the metal oxide may be mixed with the carbon black in a ratio of about 20:80 to about 99:1.

According to an embodiment, a rechargeable lithium battery including a negative electrode including the negative active material, a positive electrode, and an electrolyte is provided.

Accordingly, the negative electrode may provide a rechargeable lithium battery having improved output and capacity characteristics.

### BRIEF DESCRIPTION OF THE DRAWINGS

FIG. 1 schematically shows the structure of a rechargeable lithium battery according to one embodiment of the present invention.

FIG. 2 is a scanning electron microscope photograph taken of the carbon black nanofiber according to Example 1.

FIG. 3 shows the preparation of a negative active material according to an embodiment of the invention.

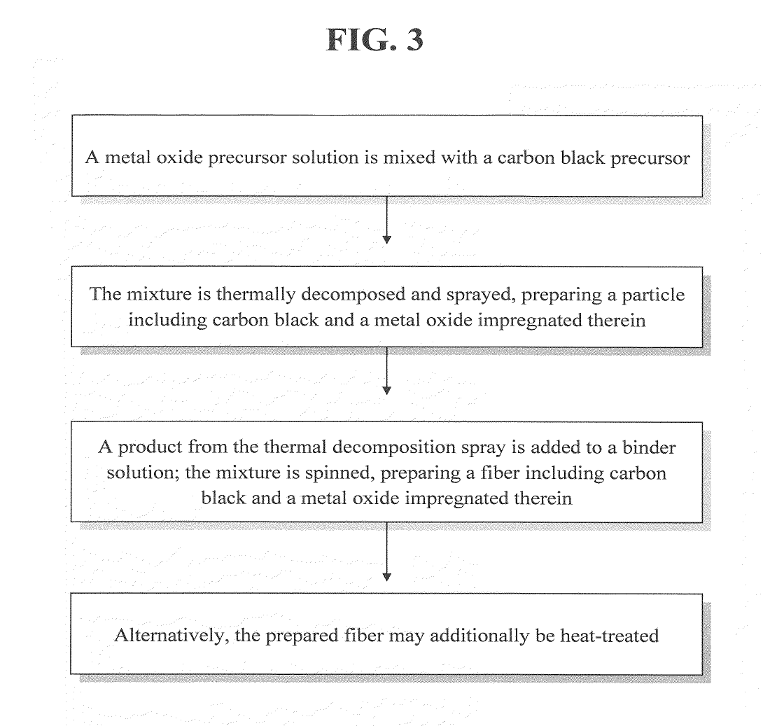

FIG. 4 shows a process of preparing a negative active material according to an embodiment of the invention.

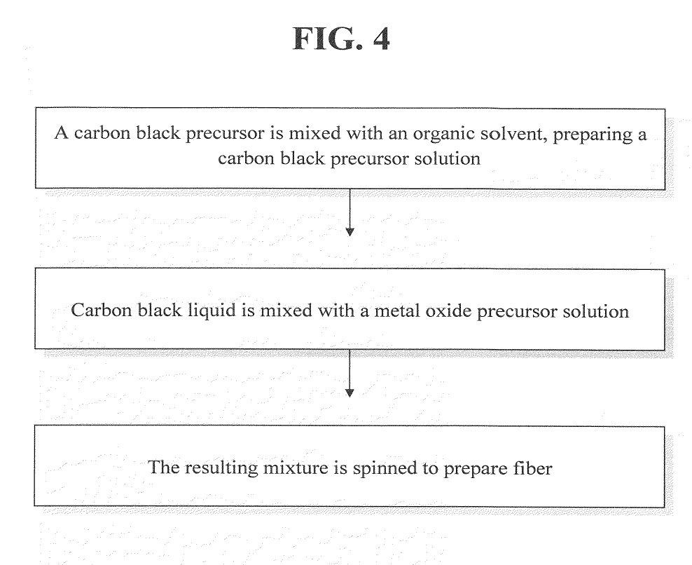

### DETAILED DESCRIPTION

Exemplary embodiments of the present invention will hereinafter be described in detail. However, these embodiments are only exemplary, and the present invention is not limited thereto.

The negative active material for a rechargeable lithium battery according to one embodiment of the present invention may include a metal oxide in an amount of about 20 wt % or more, and has a specific surface area of about 500 m²/g or less.

The negative active material may have a specific surface area ranging from about 10 m²/g to about 500 m²/g.

In one embodiment of the present invention, when a negative active material has a specific surface area of more than about 500 m²/g, it may absorb too much of the solvent and bring about low viscosity when it is prepared into a slurry-type negative active material composition. Accordingly, the composition may not be coated on a current collector but may be formed into an SEI (solid electrolyte interface) layer.

The negative active material may be a fiber including carbon black in which a metal oxide is internally impregnated and combined. This fiber includes only carbon black and a metal oxide internally doped thereon.

“Internally doped” as used herein means that the metal oxide can be present inside or outside of the fiber. Furthermore, “internally doped” can also mean that the metal oxide is substantially only inside the fiber. Metal oxide may be present outside of the carbon black or it may be present in voids between the carbon black agglomerates.

The negative active material may include a metal oxide in an amount of about 20 wt % or more, or in an amount ranging from about 20 wt % to about 99 wt % in another embodiment.

When a metal is included in an amount of less than about 20 wt %, a battery may not have a sufficient cycle-life characteristic and capacity during charge and discharge at a high rate.

The metal oxide and the carbon black are mixed in a weight ratio ranging from about 20:80 to about 99:1. When the metal oxide nanoparticle and the carbon black are mixed within this range, a negative active material may have excellent capacity and no deterioration of cycle-life characteristic due to agglomeration of metal oxide nanoparticles and carbon black, in other words, it may have an excellent cycle-life characteristic.

The fiber may have nanofiber having an average diameter ranging from about 50 nm to about 900 nm. In another embodiment, the fiber may have an average diameter ranging from about 150 nm to about 900 nm. When the fiber has an average diameter within these ranges, a metal oxide nanoparticle is internally well-impregnated, accomplishing excellent performance. In addition, a negative active material may efficiently contact an electrolyte and deliver electrons.

The metal oxide may include SnO₂, TiO₂, Fe₂O₃, Fe₃O₄, CoO, CO₃O₄, CuO, ZnO, In₂O₃, NiO, MoO₃, WO₃, or combinations thereof.

In the negative active material according to one embodiment of the present invention, the metal oxide may be combined with carbon black through a binder. The binder may include any electrically emissible polymer compound. The binder may include polyacrylonitrile, 6,6-nylon, polyurethane, polybenzimidazole, polycarbonate, polyvinyl alcohol, polyacetic acid, polyethylene-co-vinylacetate, polymethylmetaacrylate, polyaniline, polyethylene oxide, collagen, polystyrene, polyvinylcarbazole, polyethylene terephthalate, polyamide, polyamideimide, polyvinylphenol, polyvinylchloride, polyacrylamide, polycaprolactone, polyvinylidene fluoride, polyester amide, polyethylene glycol, polypyrrole, or a combination thereof.

In one embodiment, considering carbon yields and conductivity after heat treatment, it is preferable that polyacrylonitrile, polycarbonate, polystyrene, polyaniline, polypyrrole, or a combination thereof is used.

The negative active material according to one embodiment of the present invention includes carbon black and a metal oxide impregnated therein and therewith, in other words, carbon black closely contacting a metal oxide as a point contact. Accordingly, the negative active material has very high conductivity. Furthermore, the carbon black absorbs all physical changes, it may suppress sharp transformation of an active material, even though a metal from the metal oxide contacts and is expanded during the charge and discharge. In addition, since the active material may not be cracked, and have less surface area due to cracks, side reactions with an electrolyte may be prevented.

On the other hand, when a carbon coating layer is merely formed on the metal-based negative active material, it expands more than the carbon coating layer during the charge and discharge. As a result, the coating layer may be cracked and detach from the metal-based negative active material. Otherwise, the metal-based negative active material may be more exposed to the outside and have more surface area due to cracks. Accordingly, it may have more side reactions with an electrolyte and consume more lithium ions, deteriorating the high rate characteristic. The carbon coating layer should be formed thicker in order to solve such problems. However, it may have a problem that lithium ions may hardly pass the thicker carbon coating layer and react with the metal-based active material therein. It also has a problem of taking a long time or deteriorating the rate characteristic and increasing voltage drop (IR drop).

This negative active material may be prepared in the following two processes.

1) Thermal Decomposition Spray and Spinning Process

First, a metal oxide precursor solution is mixed with a carbon black precursor. In the metal oxide precursor solution, dimethyl formamide, chloroform, N-methylpyrrolidone, tetrahydrofuran, sulfuric acid, nitric acid, acetic acid, hydrochloric acid, ammonia, alcohol, distilled water, or a combination thereof may be used for a solvent. The metal oxide precursor may include sulfate, ethoxide, buthoxide, hydroxide, acetate, chloride including a metal selected from Sn, Ti, Fe, Co, Cu, Zn, In, Ni, Mo, W, or combinations thereof, or combinations thereof.

The metal oxide precursor solution may have a concentration ranging from about 1 wt % to about 50 wt %. When the metal oxide precursor solution has a concentration within this range, it may have a uniform dispersion phase which is good for spinning when mixed with carbon black.

The carbon black precursor may include a hydrocarbon gas such as methane, propane, and the like, heavy fuel oil, or combinations thereof.

The metal oxide precursor may be mixed with a carbon black precursor in a weight ratio ranging from 20:80 to 99:1 in a final product.

Next, the mixture is thermally decomposed and sprayed, preparing a particle including carbon black and a metal oxide impregnated therein. The thermal decomposition spray process may be performed at a temperature ranging from about 800° C. to about 1000° C.

Then, a product from the thermal decomposition spray is added to a binder solution. The mixture is spinned, preparing a fiber including carbon black and a metal oxide impregnated therein. The binder solution may include polyacrylonitrile, 6,6-nylon, polyurethane, polybenzimidazole, polycarbonate, polyvinyl alcohol, polylacetic acid, polyethylene-co-vinylacetate, polymethylmetaacrylate, polyaniline, polyethylene oxide, collagen, polystyrene, polyvinylcarbazole, polyethylene terephthalate, polyamide, polyamideimide, polyvinylphenol, polyvinylchloride, polyacrylamide, polycaprolactone, polyvinylidene fluoride, polyester amide, polyethylene glycol, polypyrrole, or combinations thereof, as the binder. In the binder solution, a solvent may be dimethyl foramide, dimethyl sulfoxide, dimethyl acetamide, sodium, sulfocyanate or a combination thereof. The binder solution has a concentration of about 5 wt % to 20 wt %.

In the binder solution, a solvent may be dimethyl formamide, chloroform, N-methylpyrrolidone, tetrahydrofuran, sulfuric acid, nitric acid, acetic acid, hydrochloric acid, ammonia, alcohol, distilled water, or combinations thereof.

The spinning procedure may be electrospinning. The electrospinning process may be performed by applying a voltage ranging from about 10 kV to about 40 kV at a spinning volumetric flow rate ranging from about 0.1 ml/h to about 5 ml/h. However, the electrospinning process may not be limited thereto, and may be adjusted under various conditions such as temperature and the like depending on a device and the like.

Alternatively, the prepared fiber may additionally be heat-treated. The heat-treatment may include a primary heat-treatment at a temperature ranging from about 220° C. to about 300° C. under an oxidizing atmosphere, and then a second heat-treatment at a temperature ranging from about 600° C. to about 1200° C. under an inert atmosphere. The oxidizing atmosphere may be oxygen, air, or a combination thereof. The inert atmosphere may be argon, nitrogen, helium, or combinations thereof.

2) Spinning with No Thermal Decomposition Spray.

A carbon black precursor is mixed with an organic solvent, preparing a carbon black precursor solution. Herein, the solvent may be the same as used in the metal oxide precursor solution.

Next, the carbon black liquid is mixed with a metal oxide precursor solution. The metal oxide precursor solution may be the same as aforementioned.

The resulting mixture is spinned to prepare fiber. This spinning process may be electrospinning performed under the aforementioned conditions.

According to one embodiment of the present invention, a rechargeable lithium battery including a negative electrode including the negative active material, a positive electrode, and an electrolyte is provided.

The negative electrode including the negative active material includes a negative active material layer and a current collector supporting the negative active material layer.

The negative active material layer may include about 95 wt % to about 99 wt % of the negative active material based on the total weight of the negative active material layer.

The negative active material layer includes a binder, and optionally a conductive material. The negative active material layer may include about 1 wt % to about 5 wt % of the binder based on the total weight of the negative active material layer. In addition, when the negative active material layer further includes a conductive material, it may include about 90 wt % to about 98 wt % of the negative active material, about 1 wt % to about 5 wt % of the binder, and about 1 wt % to about 5 wt % of the conductive material.

The binder improves properties for binding active material particles with one another and with a current collector. The binder may include a non-water-soluble binder, a water-soluble binder, or combinations thereof.

Examples of the non-water-soluble binder include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, and combinations thereof.

The water-soluble binder includes a styrene-butadiene rubber, an acrylated styrene-butadiene rubber, polyvinyl alcohol, sodium polyacrylate, a copolymer including propylene and a C2 to C8 olefin, a copolymer of (meth)acrylic acid and (meth)acrylic acid alkyl ester, or combinations thereof.

When the water-soluble binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkaline metal salts thereof. The alkaline metal may be sodium (Na), potassium (K), or lithium (Li). The cellulose-based compound may be included in an amount of 0.1 to 3 parts by weight based on 100 parts by weight of the binder.

The conductive material is included to improve electrode conductivity. Any electrically conductive material may be used as a conductive material unless it causes a chemical change. Examples of the conductive material include carbon-based materials such as natural graphite, artificial graphite, carbon black, acetylene black, ketjen black, carbon fiber, and the like; a metal-based material including a metal powder or a metal fiber including copper, nickel, aluminum, silver, and the like; a conductive polymer such as polyphenylene derivative, and the like; or mixtures thereof.

The current collector includes a copper foil, a nickel foil, a stainless steel foil, a titanium foil, a nickel foam, a copper foam, a polymer substrate coated with a conductive metal, or combinations thereof.

The positive electrode includes a current collector and a positive active material layer disposed on the current collector. The positive active material may include lithiated intercalation compounds that reversibly intercalate and deintercalate lithium ions. Examples of the positive active material include a composite oxide including at least one selected from the group consisting of cobalt, manganese, and nickel, as well as lithium. In one embodiment, the following lithium-containing compounds may be used. LiₐA_{1-b}X_{b}D₂ (0.90≦a≦1.8, 0≦b≦0.5); LiₐA_{1-b}^{X}_{b}O_{2-c}D_{c} (0.90≦a≦1.8, 0≦b≦0.5, 0≦c≦0.05); LiₐE_{1-b}X_{b}O_{2-c}D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}CO_{b}X_{c}O_{2-α}T_{α} (0.90≦a≦1.8, 0≦b≦0.5, 0≦c≦0.05, 0<α<2); LiₐNi_{1-b-c}CO_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}CO_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃(0≦f≦2); and LiFePO₄

In the above Chemical Formulae, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and combinations thereof; and J is selected from the group consisting of V, Cr, Mn, Co, Ni, Cu, and combinations thereof.

The positive active material may include the positive active material with a coating layer, or a compound of the active material and the active material coated with a coating layer. The coating layer may include at least one coating element compound selected from the group consisting of an oxide of a coating element and a hydroxide of a coating element, an oxyhydroxide of a coating element, a oxycarbonate of a coating element, and a hydroxycarbonate of the coating element. The compound for the coating layer may be either amorphous or crystalline. The coating element included in the coating layer may be selected from the group consisting of Mg, Al, Co, K, Na, Ca, Si, Ti, V, Sn, Ge, Ga, B, As, Zr, and combinations thereof. The coating process may include any conventional processes as long as it does not cause any side effects on the properties of the positive active material (e.g., spray coating, immersing), which is well known to persons having ordinary skill in this art, so a detailed description thereof is omitted.

The positive active material layer may also include a binder and a conductive material.

The binder improves binding properties of the positive active material particles to each other and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidenefluoride, polyethylene, polypropylene, a styrene-butadiene rubber, an acrylated styrene-butadiene rubber, an epoxy resin, nylon, and the like, but is not limited thereto.

The conductive material improves electrical conductivity of a negative electrode. Any electrically conductive material can be used as a conductive agent unless it causes a chemical change. Examples of the conductive material include a carbon-based material such as natural graphite, artificial graphite, carbon black, acetylene black, ketjen black, a carbon fiber, and the like; a metal powder or metal fiber of copper, nickel, aluminum, silver, and the like; a conductive polymer such as a polyphenylene derivative; or mixtures thereof.

The current collector may include Al, but is not limited thereto.

In the positive electrode, a positive active material, a conductive material, and a binder may be mixed in suitable ratios, and for example, in the positive active material layer, the positive active material may be included in an amount of 90 wt % to 98 wt % based on the total weight of the positive active material layer. The binder and conductive material may be included in amounts of 1 wt % to 5 wt % based on the total weight of the positive active material layer, respectively.

The negative and positive electrodes may be fabricated by a method including mixing the active material and a binder, and optionally a conductive material to provide an active material composition, and coating the composition on a current collector. The electrode manufacturing method is well known, and thus is not described in detail in the present specification. The solvent includes N-methylpyrrolidone and the like, but is not limited thereto.

In a rechargeable lithium battery according to one embodiment, an electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethyl acetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio can be controlled in accordance with a desirable battery performance.

The carbonate-based solvent may include a mixture of a cyclic carbonate and a linear carbonate. The cyclic carbonate and the chain carbonate are mixed together in a volume ratio of 1:1 to 1:9. When the mixture is used as an electrolyte, the electrolyte performance may be enhanced.

In addition, the non-aqueous organic electrolyte may further include a mixture of a carbonate-based solvent and an aromatic hydrocarbon-based solvent. The carbonate-based solvent and the aromatic hydrocarbon-based solvent may be mixed together in a volume ratio ranging from 1:1 to 30:1.

The aromatic hydrocarbon-based organic solvent may be represented by the following Chemical Formula 1.

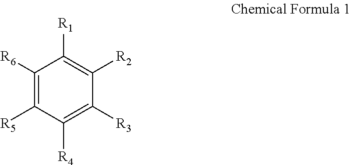

In Chemical Formula 1, R₁ to R₆ are independently selected from the group consisting of hydrogen, a halogen, a C1 to C10 alkyl group, a C1 to C10 haloalkyl group, and combinations thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include vinylene carbonate, an ethylene carbonate-based compound of the following Chemical Formula 2, or a combination thereof in order to improve cycle-life.

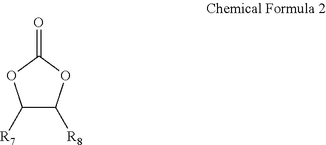

In Chemical Formula 2, R₇ and R₈ are independently selected from the group consisting of hydrogen, a halogen, a cyano group (CN), a nitro group (NO₂), and a C1 to C5 fluoroalkyl group, provided that at least either of R₇ and R₈ is selected from the group consisting of a halogen, a cyano group (CN), a nitro group (NO₂), and a C1 to C5 fluoroalkyl group, and all R₇ and R₈ are not hydrogen.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the additive for improving cycle-life may be adjusted within an appropriate range.

The lithium salt is dissolved in an organic solvent, supplies lithium ions in the battery, performs a basic operation of a rechargeable lithium battery, and improves lithium ion transport between positive and negative electrodes. Non-limiting examples of the lithium salt include at least one supporting salt selected from LiPF₆, LiBF₄, LiSbF₆, LiAsF₆, LiN(SO₂C₂F₅)₂, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration ranging from 0.1 M to 2.0 M. When the lithium salt is included at the above concentration range, electrolyte performance and lithium ion mobility may be enhanced due to optimal electrolyte conductivity and viscosity.

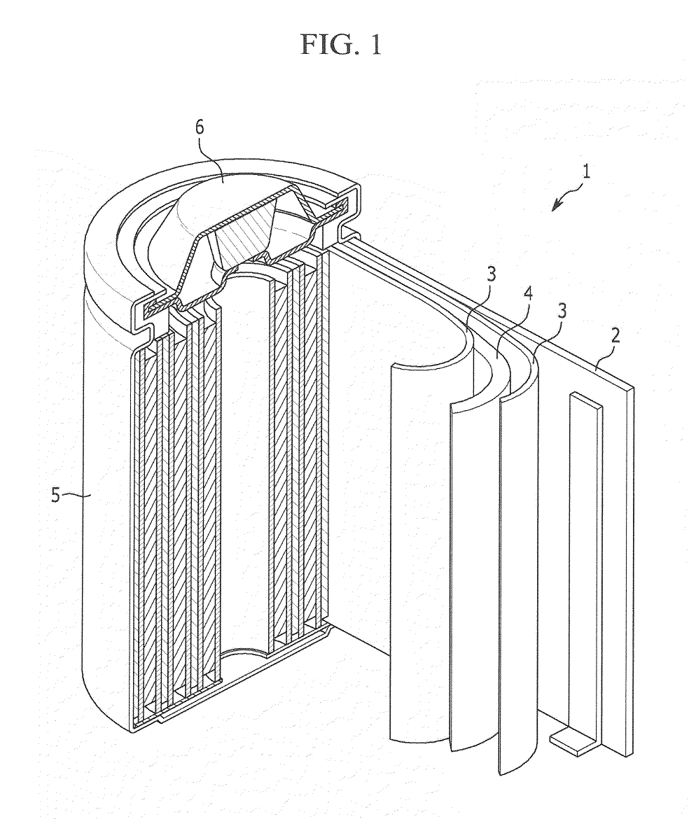

FIG. 1 provides a schematic view showing a representative structure of a rechargeable lithium battery according to one embodiment. As shown in FIG. 1, the rechargeable lithium battery 1 includes a battery case 5 including a positive electrode 3, a negative electrode 2, a separator interposed between the positive electrode 3 and the negative electrode 2, an electrolyte impregnated therein, and a sealing member 6 sealing the battery case 5.

The rechargeable lithium battery may further include a separator between the negative electrode and the positive electrode, as needed. Non-limiting examples of suitable separator materials include polyethylene, polypropylene, polyvinylidene fluoride, and multi-layers thereof, such as a polyethylene/polypropylene double-layered separator, a polyethylene/polypropylene/polyethylene triple-layered separator, and a polypropylene/polyethylene/polypropylene triple-layered separator.

The following examples illustrate the present invention in more detail. These examples, however, are not in any sense to be interpreted as limiting the scope of this disclosure.

### Example 1

10 g of SnCl₂ was dissolved in 30 g of tetrahydrofuran, preparing a SnCl₂ solution, and 30 g of heavy oil was added thereto. The mixture was agitated for one hour at room temperature.

The resulting mixture was thermally decomposed and sprayed at about 900° C., preparing carbon black nanoparticles in which SnO₂ was internally impregnated and composited. Herein, the SnO₂ and the carbon black were mixed in a weight ratio of 75:25. The nanoparticles had an average diameter of about 20 nm.

Next, 5 g of polyacrylonitrile (Aldrich) was sufficiently dissolved in 60 g of dimethyl formamide, preparing a binder solution.

Then, 15 g of the carbon black nanofiber doped with SnO₂ was added to the binder solution. The mixture was agitated with ultrasonic waves and mechanically.

The resulting product was electrospinned, preparing a fiber-phased precursor. The electrospinning was performed with a voltage ranging from about 15 kV to about 20 kV at a spinning volumetric flow rate of about 2 ml/h. The fiber-phased precursor was primarily heat-treated at about 280° C. under an oxygen atmosphere as an oxidizing atmosphere, and then secondarily heat-treated for 1 hour under a nitrogen inert atmosphere at 700° C. In this way, the carbon black nanofiber doped with SnO₂ was prepared as a negative active material, in which the SnO₂ and the carbon black were combined through polyacrylonitrile. Herein, the SnO₂ and the carbon black were mixed in a ratio ranging from about 85 wt %:15 wt %. The nanofiber had an average diameter of about 200 nm. In addition, the nanofiber including carbon black negative active material included SnO₂ in an amount of about 80 wt % and had a specific surface area of about 250 m²/g.

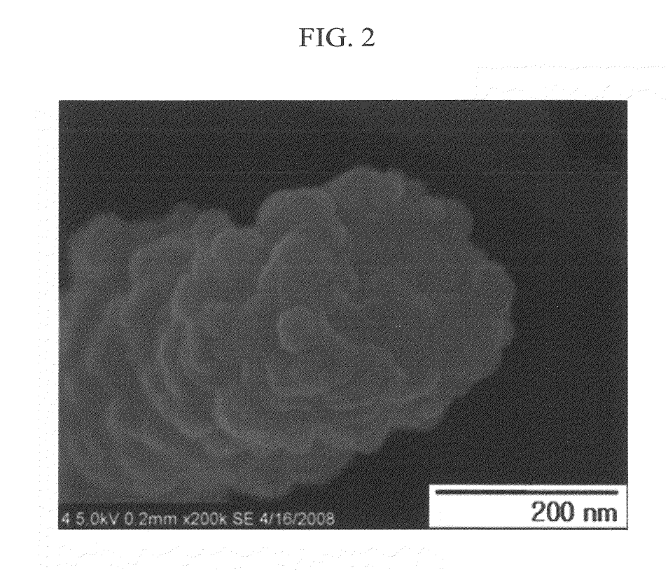

The nanofiber including carbon black was photographed with a scanning electron microscope. The result is provided in FIG. 2. As shown in FIG. 2, a carbon black cluster doped with SnO₂ existed inside and outside of the fiber. Resultantly, a nanofiber in which the carbon black was combined with SnO₂ through electrical emission with high density was prepared. Each cluster therein was organically connected with one another.

### Example 2

90 wt % of the nanofiber including carbon black negative active material according to Example 1 was mixed with 10 wt % of a polyvinylidene fluoride binder in an N-methylpyrrolidone solvent, preparing a negative active material slurry. The negative active material slurry was coated on a Cu-foil current collector, fabricating a negative electrode.

The negative electrode, a lithium metal counter electrode, and an electrolyte were used to fabricate a pouch-type half-cell. The electrolyte was prepared by mixing ethylene carbonate in which 1.5M LiPF₆ was dissolved, dimethyl carbonate, and diethyl carbonate in a volume ratio of 3:3:1.

### Example 3

A nanofiber including carbon black negative active material as a nanofiber including carbon black, doped with SnO₂ was prepared according to the same method as Example 1, except for being secondarily heat-treated at 900° C. The SnO₂ and the carbon black were combined through polyacrylonitrile. Herein, the SnO₂ and the carbon black were mixed in a ratio of 85 wt %:15 wt %. The nanofiber had an average diameter of about 200 nm. In addition, the nanofiber including carbon black, negative active material included SnO₂ in an amount of 80 wt %, and had a specific surface area of about 150 m²/g.

### Example 4

20 g of SnCl₂ was dissolved in 30 g of tetrahydrofuran, preparing a SnCl₂ solution, and 30 g of heavy oil was added to the SnCl₂ solution. This mixture was used according to the same method as Example 1, preparing carbon black nanoparticles doped with SnO₂. Herein, the SnO₂ was mixed with the carbon black in a ratio of about 80:20. The nanoparticles had an average diameter of about 30 nm.

A nanofiber including carbon black doped with SnO₂, in which the SnO₂ was combined with the carbon black through polyacrylonitrile, was prepared according to the same method as Example 2, except for adding 15 g of the carbon black nanoparticles doped with SnO₂ to the binder solution according to Example 1.

### Example 5

90 wt % of the nanofiber including carbon black negative active material according to Example 4 was mixed with 10 wt % of a polyvinylidene fluoride binder in a N-methylpyrrolidone solvent, preparing a negative active material slurry. The negative active material slurry was coated on a Cu foil current collector, fabricating a negative electrode.

The negative electrode was used with a lithium metal counter electrode and an electrolyte, fabricating a pouch-type half-cell. The electrolyte was prepared by mixing ethylene carbonate in which 1.5M LiPF₆ was dissolved, dimethyl carbonate, and diethyl carbonate in a volume ratio of 3:3:1.

### Comparative Example 1

A negative active material slurry was prepared by mixing 80 wt % of SnO₂ (Aldrich, average particle diameter of about 78 μm) negative active material, 5 wt % of carbon black, and 15 wt % of a polyvinylidene fluoride binder in an N-methylpyrrolidone solvent. This negative active material slurry was coated on a Cu foil current collector, fabricating a negative electrode.

The negative electrode was used with a lithium metal counter electrode and an electrolyte, fabricating a pouch type half-cell. The electrolyte was prepared by mixing ethylene carbonate in which 1.5M LiPF₆ was dissolved, dimethyl carbonate, and diethyl carbonate in a volume ratio of 3:3:1.

### Comparative Example 2

5 g of SnCl₂ was mixed with 5 g of polyacrylonitrile in a dimethyl formamide phase. The mixture was heat-treated at about 900° C. and then ground, preparing a negative active material having a mixed phase of SnO₂ particles and polyacrylonitrile-based amorphous carbon, and an average particle diameter of about 10 μm.

80 wt % of the negative active material was mixed with 5 wt % of carbon black and 15 wt % of a polyvinylidene fluoride binder in an N-methylpyrrolidone solvent, preparing a negative active material slurry. This negative active material slurry was coated on a Cu foil current collector, fabricating a negative electrode.

The negative electrode, a lithium metal counter electrode, and an electrolyte were used to fabricate a pouch-type half-cell. The electrolyte was prepared by mixing ethylene carbonate in which 1.5M LiPF₆ was dissolved, dimethyl carbonate, and diethyl carbonate in a volume ratio of 3:3:1.

The half-cells according to Examples 2, 3, 5, and 8 and Comparative Examples 1 to 2 were charged and discharged once at a 1 C rate, and then measured regarding initial charge and discharge efficiency (discharge capacity/charge capacity). The results are provided in the following Table 1.

Next, they were charged and discharged at a 0.2 C rate and measured regarding charge capacity. The results are provided in the following Table 1.

In addition, the half-cells according to Examples 2, 3, and 5 and Comparative Examples 1 to 2 were charged and discharged once at 5 C and 10 C rates, respectively, and evaluated regarding discharge capacity ratio (5 C/1 C and 10 C/1 C). The results are provided in the following Table 1

Furthermore, the half-cells according to Examples 2, 3, and 5 and Comparative Example 1 to 2 were charged and discharged 50 times at a 10 C rate, and then evaluated regarding the 50^{th} discharge capacity against the 1^{st} discharge capacity (50^{th} discharge capacity/1^{st} discharge capacity) as cycle-life %. The results are provided in the following Table 1.

TABLE 1

| | Initial | 0.2 C charge | Discharge | Discharge | Cycle-life % |
|---|---|---|---|---|---|
| | efficiency | capacity | capacity % | capacity % | (50th discharge capacity/ |
| | (%) | (mAh/g) | (5 C/1 C) | (10 C/1 C) | 1st discharge capacity) |
| Example 2 | 47.37 | 657 | 86 | 75 | 84 |
| Example 3 | 75.67 | 594 | 88 | 73 | 86 |
| Example 5 | 45.21 | 614 | 79 | 69 | 83 |
| Comparative | 43.86 | 672 | 58 | 27 | 46 |
| Example 1 | | | | | |
| Comparative | 39.85 | 548 | 65 | 59 | 58 |
| Example 2 | | | | | |

As shown in Table 1, the cells of Examples 2, 3, and 5 had excellent high rate (5 C and 10 C) and cycle-life characteristics compared with the ones of Comparative Examples 1 and 2.

The reason is that the negative active materials used in Examples 2, 3, and 5 included a metal oxide nanoparticles doped on fiber including carbon black as a point contact with one another, and may not be transformed since the carbon black prevented the metal oxide nanoparticles from being expanded during the charge and discharge, therefore having no substrate shape change. Furthermore, since the metal oxide nanoparticle had a very small size, lithium ions could be sufficiently and quickly diffused.

On the contrary, when SnO₂ was used as a negative active material in Comparative Example 1, the SnO₂ reacted with lithium ions during the charge and reduced to Sn. This Sn reduction occurred on the surface of the SnO₂ surface. The Sn formed on the surface had a low ion diffusion speed, thereby deteriorating diffusion rate of lithium ions during the charge. As a result, the SnO₂ did not have an active material reaction over all the reduced Sn particle but only on the surface of the Sn particle down to a particular depth. Accordingly, the negative active material might be cracked at the interface (between a region where the reaction occurs and another region where the reaction does not occur), sharply deteriorating high rate and cycle-life characteristics.

In addition, the half-cell of Comparative Example 2 included a mixed negative active material including SnO₂ nanoparticles and amorphous carbon, and had a better cycle-life characteristic than the one of Comparative Example 1. However, the SnO₂ nanoparticles were well dispersed in amorphous carbon at first and combined with one another, and thus became larger and larger in size during the charge. Thus, they might be diffused inside carbon of lithium ions during the charge and then inside a metal material. Accordingly, they might have an energy barrier on the interface and bring about small capacity and low high rate output compared with the one of the examples.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. A negative active material for a rechargeable lithium battery, comprising 20 wt % or more of a metal oxide and having a specific surface area of about 500 m²/g or less.

2. The negative active material of claim 1, which is a fiber comprising carbon black internally doped with a metal oxide.

3. The negative active material of claim 2, which further comprises a binder.

4. The negative active material of claim 1, which has a specific surface area ranging from about 10 m²/g to about 500 m²/g.

5. The negative active material of claim 1, which comprises a metal oxide in an amount ranging from about 20 wt % to about 99 wt %.

6. The negative active material of claim 2, wherein the metal oxide is mixed with the carbon black in a weight ratio ranging from about 50:50 to about 99:1.

7. The negative active material of claim 1, wherein the metal oxide comprises SnO₂, TiO₂, Fe₂O₃, Fe₃O₄, CoO, CO₃O₄, CuO, ZnO, In₂O₃, NiO, MoO₃, WO₃, or combinations thereof.

8. The negative active material of claim 2, wherein the fiber is a nanofiber having an average diameter ranging from about 50 nm to about 900 nm.

9. The negative active material of claim 3, wherein the binder comprises one or more selected from polyacrylonitrile, 6,6-nylon, polyurethane, polybenzimidazole, polycarbonate, polyvinyl alcohol, polyacetic acid, polyethylene-co-vinylacetate, polymethylmetaacrylate, polyaniline, polyethylene oxide, collagen, polystyrene, polyvinylcarbazole, polyethylene terephthalate, polyamide, polyamideimide, polyvinylphenol, polyvinylchloride, polyacrylamide, polycaprolactone, polyvinylidene fluoride, polyester amide, polyethylene glycol, polypyrrole, or combinations thereof.

10. A rechargeable lithium battery comprising:
a negative electrode comprising a negative active material;
a positive electrode; and
an electrolyte,
wherein the negative active material comprises 20 wt % or more of a metal oxide and has a specific surface area of 500 m²/g or less.

11. The rechargeable lithium battery of claim 10, wherein the negative active material is a fiber comprising carbon black internally doped with a metal oxide.

12. The rechargeable lithium battery of claim 11, wherein the negative active material further comprises a binder.

13. The rechargeable lithium battery of claim 10, wherein the negative active material has a specific surface area ranging from about 10 m²/g to about 500 m²/g.

14. The rechargeable lithium battery of claim 10, wherein the negative active material comprises a metal oxide in an amount ranging from about 20 wt % to about 99 wt %.

15. The rechargeable lithium battery of claim 11, wherein the metal oxide is mixed with the carbon black in a weight ratio ranging from about 50:50 to about 99:1.

16. The rechargeable lithium battery of claim 10, wherein the metal oxide comprises SnO₂, TiO₂, Fe₂O₃, Fe₃O₄, CoO, Co₃O₄, CuO, ZnO, In₂O₃, NiO, MoO₃, WO₃, or combinations thereof.

17. The rechargeable lithium battery of claim 11, wherein the fiber is a nanofiber having an average diameter ranging from about 50 nm to about 900 nm.

18. The rechargeable lithium battery of claim 12, wherein the binder comprises one or more selected from polyacrylonitrile, 6,6-nylon, polyurethane, polybenzimidazole, polycarbonate, polyvinyl alcohol, polyacetic acid, polyethylene-co-vinylacetate, polymethylmetaacrylate, polyaniline, polyethylene oxide, collagen, polystyrene, polyvinylcarbazole, polyethylene terephthalate, polyamide, polyamideimide, polyvinylphenol, polyvinylchloride, polyacrylamide, polycaprolactone, polyvinylidene fluoride, polyester amide, polyethylene glycol, polypyrrole, or combinations thereof.
